(19) United States
(12) Patent Application Publication
(10) Pub. No.: US 2003/0037632 A1
(43) Pub. Date: Feb. 27, 2003

(54) Accelerator pedal for a vehicle

(76) Inventor: Young-Gun Cho, Seoul (KR)

Correspondence Address: Pennie & Edmonds, LLP, 3300 Hillview Avenue, Palo Alto, CA, 94304, US

(21) Appl. No.: 10/224,846

(22) Filed: Aug. 20, 2002

(30) Foreign Application Priority Data
Aug. 22, 2001 (KR) 2001-50610

(51) Int. Cl. G05G 1/14

(52) U.S. Cl. 74/512

(57) ABSTRACT

An accelerator pedal for a vehicle, wherein a bracket secured to or forming part of the vehicular body is hinged to an upper rotary arm, a lower rotary arm and a connecting arm, preferably to constitute a quadric link. The connecting arm is adjusted in length thereof to allow a rotary center of a driver's foot stepping on the foot pad to correspond to that of a pedal arm, thereby enabling the accelerator pedal to at least approximate the rotary track of a driver's foot to discourage slippage of the driver's foot therefrom, and improve the manipulating stability and manipulability of the accelerator pedal.

### FIELD OF THE INVENTION

The present invention relates to an accelerator pedal for a vehicle, and more particularly, to an accelerator pedal for a vehicle adapted to track the driver's foot.

### BACKGROUND OF THE INVENTION

Generally, when a driver steps on an accelerator pedal to open the throttle valve, the amount of mixed air supplied to the combustion chamber is increased to increase output of the engine, thereby accelerating the speed of a vehicle. As shown in FIG. 1, an accelerator pedal typically includes a pedal arm 1, an upper point thereof being hinged to a bracket (not shown) mounted at a dash panel, a wire 3 connected to an upper side of a hinge point H₁′ of the pedal arm 1 and connected to an accelerating lever, and a foot pad 2 formed at a lower end of the pedal arm 1. When the driver steps on foot pad 2, the pedal arm 1 is rotated clockwise about the hinge point H₁′ to pull the wire 3 and to thereby pull the accelerating lever at the throttle body. As a result, the throttle valve is opened to increase engine output and subsequently accelerate the speed of a vehicle.

As shown in FIG. 2, the rotary center (Cp) of the accelerator pedal is at the hinge point H₁′ such that the track of the foot pad 2 during manipulation of the accelerating pedal circles about the rotary center (Cp), while the rotary center (C_{f}) of the driver's foot stepping on the foot pad 2 is located at the heel of the foot such that the rotary track of the driver's foot circles around the rotary center (C_{f}). Thus, the track of foot pad 2 and that of driver's foot are mutually tangent circular tracks. When the driver depresses the foot pad 2 further, a track difference therebetween from an initial point (A; tangent point of two circular tracks) where the foot is placed on the foot pad 2 is gradually increased (distance between Ap and Af is increased). As a result, the foot has a tendency to slip from the foot pad 2 to decrease the manipulating stability of accelerating pedal and manipulability as well.

### SUMMARY OF THE INVENTION

The present invention provides an accelerator pedal for a vehicle adapted to accord the rotary track of the accelerator pedal with that of a driver's foot to discourage slipping of the driver's foot therefrom, thereby improving the manipulating stability and manipulability of the accelerator pedal.

In accordance with an embodiment of the present invention, a bracket is secured to a vehicle body. Upper and lower rotary arms are hinged at each end thereof to both ends of the bracket. A connecting arm is hinged at both ends thereof to the other ends of the upper and lower rotary arms and integrally formed with a pedal arm. A foot pad is formed at a lower end of the pedal arm. A wire connects the upper or lower rotary arms with the accelerator pedal, where the connecting arm is adjusted lengthwise in order to accord an instant center of the connecting arm with the rotary center of a driver's foot stepping on the foot pad. As a result, because the rotary center of the pedal arm secured at the connecting arm accords with the rotary center of a driver's foot, the rotary track of the foot pad and that of the driver's foot follow one another to prevent slippage of the foot at the foot pad.

In a further embodiment, an accelerator pedal for a vehicle comprises a pedal arm, a pedal connected to the pedal arm, and a pivoting mechanism cooperating with the pedal arm, configured to provide a radius of a path of the pedal to be concentric with a radius of a path of a driver's foot in response to application of a downward force to the pedal by the driver's foot. The pivoting mechanism comprises a bracket securable to a vehicle body, an upper arm having a first end and a second end, a lower arm having a first end and a second end, wherein the bracket is pivotally coupled adjacent the first ends of the upper and lower arms at respective hinge points. A connecting arm pivotally coupled near said second ends of the upper and lower arms operates such that application of a downward force to the pedal by a driver's foot causes the connecting arm and the upper and lower arms to rotate downwardly.

The accelerator pedal, according to this embodiment, comprises a wire connected to a throttle. The wire is connected either to the upper or the lower arm at a point closer to the first end of the upper and lower arms than the respective hinge points of the upper and lower arms, such that application of a downward force to the pedal by a driver's foot causes the wire to open a valve of the throttle.

### BRIEF DESCRIPTION OF THE DRAWINGS

For fuller understanding of the nature and objects of the invention, reference should be made to the following detailed description taken in conjunction with the accompanying drawings in which:

FIG. 1 is a schematic drawing of an accelerator pedal according to the prior art;

FIG. 2 is a schematic drawing illustrating the tracks of an accelerator pedal and a foot when the accelerator pedal is manipulated according to the prior art;

FIG. 3 is a schematic drawing of an accelerator pedal according to the present invention;

FIG. 4 is a schematic drawing illustrating the rotary center of an accelerator pedal corresponding with that of a driver's foot according to the present invention; and

FIG. 5 is a schematic drawing illustrating the tracks of an accelerator pedal and the driver's foot when the accelerator pedal is manipulated according to the present invention.

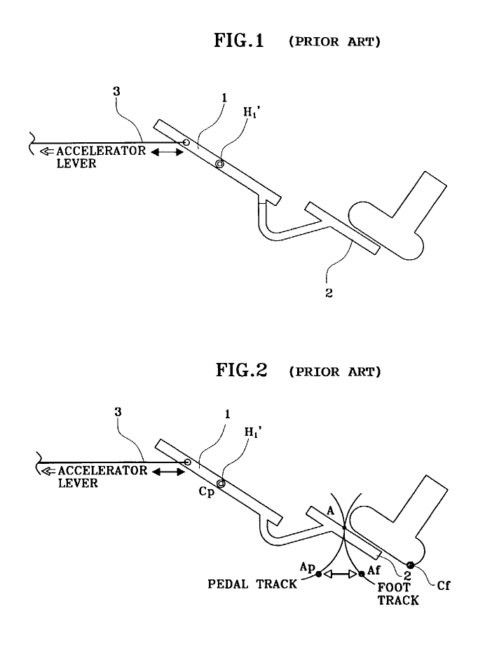

### DETAILED DESCRIPTION OF THE INVENTION

Now, an embodiment of the present invention will be described in detail with reference to the accompanying drawings.

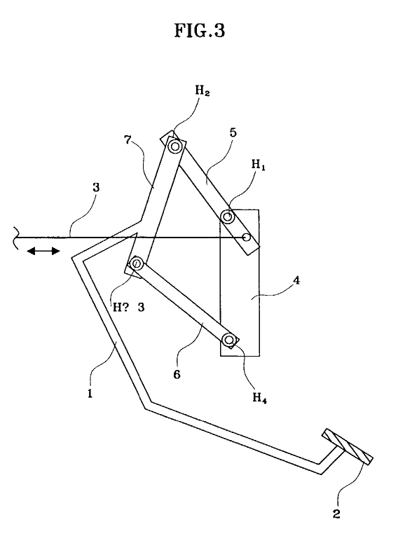

As shown in FIG. 3, upper and lower rotary arms 5 and 6 are hinged (hinge points H₁ and H₄) at each end thereof to upper and lower ends of bracket 4 secured at a vehicle body (e.g., at an appropriate position on the dash panel). Alternatively, braket 4, rather than being a separate piece, may comprise an integral portion of the vehicle body or dash panel. The upper and lower rotary arms 5 and 6 are hinged (hinge points H₂ and H₃) at the other ends thereof to both ends of connecting arm 7, while the connecting arm 7 is secured at a midsection thereof to an upper end of a pedal arm 1. The pedal arm 1 is formed at a lower portion thereof with a foot pad 2. A wire 3 connected to an accelerator lever is connected to a lower end of the upper rotary arm 5.

When a driver steps on the foot pad 2, the connecting arm 7 is rotated around a kinematic rotary center (described later in detail), and in a related communicating movement with the rotation of the connecting arm 7, the upper rotary arm 5 is rotated around the hinge point (H₁) about the bracket 4 such that the wire 3 connected to the lower end of the upper rotary arm 5 is pulled to give rise to acceleration of a vehicle. It should be noted that the bracket 4, the upper rotary arm 5, the connection arm 7 and the lower rotary arm 6 preferably form quadric links with four hinge points.

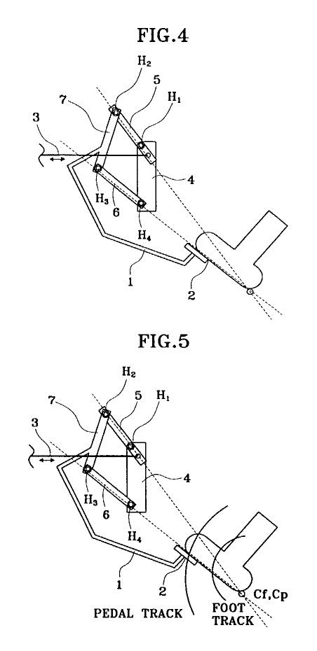

In a quadric link system, a momentary center of any link is a point where extensions of two links are crossed. Thus, in a preferred embodiment an instant center of the connecting arm 7 is a crossing point between a line connecting the two hinge points H₂ and H₁ of upper rotary arm 5 and a line connecting the two hinge points H₃ and H₄ of the lower rotary arm 6, as shown in FIG. 4.

The pedal arm 1, however, is secured to connecting arm 7 such that the rotary center of pedal arm 1 coincides with the instant center of the connecting arm 7. As a result, the rotary center of the foot pad 2 formed on the pedal arm 1 is the same as the instant center of the connecting arm 7. The length of the connecting arm 7 can be appropriately adjusted according to environmental layout conditions to accord the rotary center of the foot pad 2 with that of a driver's foot, i.e., heel of the driver.

When the rotary center (Cp) of the pedal arm 1 and the rotary center (Cf) of the driver's foot coincide, the rotary track of the foot pad 2 and that of the foot correspond as shown in FIG. 5 to help prevent the driver's foot from slipping on the surface of the foot pad 2. It should be noted that while in FIG. 5 it may appear that both tracks are not exactly matched, tracking lines at any point within the contact range of the foot on the foot pad 2 do coincide. As a result, the foot pad 2 can be positioned right under the driver's foot within the entire rotary route of the foot pad 2 to improve manipulative stability and manipulability of the accelerator pedal.

Meanwhile, although the wire 3 connected to the accelerator lever are connected to a predetermined portion underneath the hinge point (H₁) of the upper rotary arm 5, the lower rotary arm 5 also effects the same type of rotary movement as that of the upper rotary arm 5 when the accelerator pedal is manipulated, such that the wire 3 may be connected to a predetermined portion underneath the hinge point (H₄) of the lower rotary arm 6. Thus, the wire 3 is pulled when the foot pad 2 is stepped, thereby enabling to perform a normal accelerating movement.

As apparent from the foregoing, there is an advantage in the accelerator pedal for a vehicle thus described according to the present invention, in that, rotary centers of an accelerator pedal and a driver's foot are coincided to accord both rotary tracks, such that, when the driver manipulates the accelerator pedal, the driver's foot is prevented from slipping, thereby enabling to establish manipulative stability to the accelerator pedal and manipulability thereof as well.

What is claimed is:

1. An accelerator pedal for vehicle, the pedal comprising:
a bracket;
upper and lower rotary arms, an end of each being hinged to opposite ends of the bracket;
a connecting arm hinged at both ends thereof to opposite ends of the upper and lower rotary arms and a pedal arm mounted thereon;
a foot pad formed underneath the pedal arm; and
a wire connecting one of the upper and lower rotary arms with a throttle.

2. The pedal as defined in claim 1, wherein the connecting arm has a length selected such that an instant center of the connecting arm at least approximately corresponds to rotation of a driver's foot when stepping on the foot pad.

3. The pedal as defined in claim 1, wherein the wire is connected to a predetermined portion underneath a hinge point of the upper rotary arm.

4. The pedal as defined in claim 1, wherein the wire is connected to a predetermined portion underneath a hinge point of the lower rotary arm.

5. The pedal as defined in claim 1, wherein the bracket is configured to be secured to a portion of the vehicle body.

6. The pedal as defined in claim 1, wherein the bracket comprises a portion of a vehicle body or dash panel.

7. An accelerator pedal for a vehicle, comprising:
a pedal arm;
a pedal connected to said pedal arm; and
a pivoting mechanism cooperating with said pedal arm, configured to provide a radius of a path of said pedal to be concentric with a radius of a path of a driver's foot in response to application of a downward force to said pedal by the driver's foot.

8. The accelerator pedal according to claim 7, wherein said pivoting mechanism comprises:
a bracket securable to a vehicle body;
an upper arm having a first end and a second end;
a lower arm having a first end and a second end, wherein said bracket is pivotally coupled adjacent the first ends of said upper and said lower arms at respective hinge points; and
a connecting arm pivotally coupled near said second ends of said upper and said lower arms such that application of a downward force to said pedal by a driver's foot causes said connecting arm and said upper and said lower arms to rotate downwardly.

9. The accelerator pedal according to claim 7, further comprising a wire connected to a throttle.

10. The accelerator pedal according to claim 9, wherein said wire is connected either to said upper or said lower arm at a point closer to said first end of said upper and said lower arms than said respective hinge points of said upper and said lower arms, such that application of a downward force to said pedal by said driver's foot causes said wire to open a valve of said throttle.

11. The accelerator pedal according to claim 8, wherein said bracket is configured to be integral with the vehicle body or secured to the vehicle body.
